(19) United States
(12) Patent Application Publication
(10) Pub. No.: US 2025/0005794 A1
(43) Pub. Date: Jan. 2, 2025

(54) DATA PROCESSING METHOD AND DEVICE

(71) Applicant: Lenovo (Beijing) Limited, Beijing (CN)

(72) Inventors: Changjian YAN, Beijing (CN); Weizhi ZHANG, Beijing (CN)

(21) Appl. No.: 18/755,075

(22) Filed: Jun. 26, 2024

(30) Foreign Application Priority Data
Jun. 27, 2023 (CN) 202310768998.9

(51) Int. Cl. G06T 7/73; G06V 10/74; G06V 20/13

(52) U.S. Cl. CPC G06T 7/74; G06V 10/761; G06V 20/13; G06T 2207/10032; G06T 2207/20081; G06T 2207/20084; G06T 2207/30184

(57) ABSTRACT

A data processing method includes: obtaining a first image collected from a target scene; obtaining a plurality of second images, each second image being an image corresponding to the target scene; determining a second target image from the plurality of second images according to the first image; obtaining a plurality of third images, the plurality of third images being images corresponding to the target scene, and each third image meeting a first viewing angle condition with the second target image; determining a third target image from the plurality of third images according to the first image; and determining viewing angle data corresponding to the first image according to viewing angle data of the third target image.

### CROSS-REFERENCE TO RELATED APPLICATION

This application claims priority to Chinese Patent Application No. 202310768998.9, filed on Jun. 27, 2023, and the entire content of which is incorporated herein by reference.

### TECHNICAL FIELD

The present disclosure relates to the technical field of image processing technology, and more particularly, to a data processing method and device.

### BACKGROUND

Currently, satellites are needed in navigation to perform perspective positioning. Thus, such current perspective positioning solution is very complicated.

### SUMMARY

One aspect of the present disclosure provides a data processing method. The method includes: obtaining a first image collected from a target scene; obtaining a plurality of second images, each second image being an image corresponding to the target scene; determining a second target image from the plurality of second images according to the first image; obtaining a plurality of third images, the plurality of third images being images corresponding to the target scene, and each third image meeting a first viewing angle condition with the second target image; determining a third target image from the plurality of third images according to the first image; and determining viewing angle data corresponding to the first image according to viewing angle data of the third target image.

Another aspect of the present disclosure provides a data processing device. The device includes a memory storing computer programs and a processor coupled to the memory and configured to execute the computer programs to: obtain a first image collected from a target scene; obtain a plurality of second images, each second image being an image corresponding to the target scene; determine a second target image from the plurality of second images according to the first image; obtain a plurality of third images, the plurality of third images being images corresponding to the target scene, and each third image meeting a first viewing angle condition with the second target image; determine a third target image from the plurality of third images according to the first image; and determine viewing angle data corresponding to the first image according to viewing angle data of the third target image.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

FIG. 1 is a flowchart of a data processing method according to some embodiments of the present disclosure;

FIG. 2 is a schematic diagram of a first viewing angle range according to some embodiments of the present disclosure;

FIG. 3 is a schematic diagram of a second viewing angle range according to some embodiments of the present disclosure;

FIG. 4 is a flowchart of another data processing method according to some embodiments of the present disclosure;

FIG. 5 is a structural diagram of a data processing device according to some embodiments of the present disclosure;

FIG. 6 is a structural diagram of an electronic device according to some embodiments of the present disclosure;

FIG. 7 is a flowchart of NERF mapping according to some embodiments of the present disclosure; and

FIG. 8 is a flowchart of viewing angle positioning in a pedestrian street scene L according to some embodiments of the present disclosure.

### DETAILED DESCRIPTION OF THE EMBODIMENTS

To make the objectives, technical solutions, and advantages of the present disclosure clearer, the technical solutions in the embodiments of the present disclosure will be clearly and completely described below in conjunction with the accompanying drawings in the embodiments of the present disclosure. Obviously, the embodiments described herein are merely some of the embodiments of the present disclosure, but not all of them. Based on the embodiments in the present disclosure, all other embodiments obtained by those of ordinary skill in the art without creative efforts should fall within the scope of protection of the present disclosure. Under the circumstances of no conflict, the embodiments and features in the present disclosure may be combined with each other arbitrarily. The processes illustrated in the flowcharts of the drawings may be a set of computer-executable instructions performed in a computer system. Although a logical order is shown in the flowcharts, in some cases the processes shown or described may be performed in an order different from described herein.

The technical solutions of the present disclosure will be further described in detail below with reference to the accompanying drawings and various embodiments of the description.

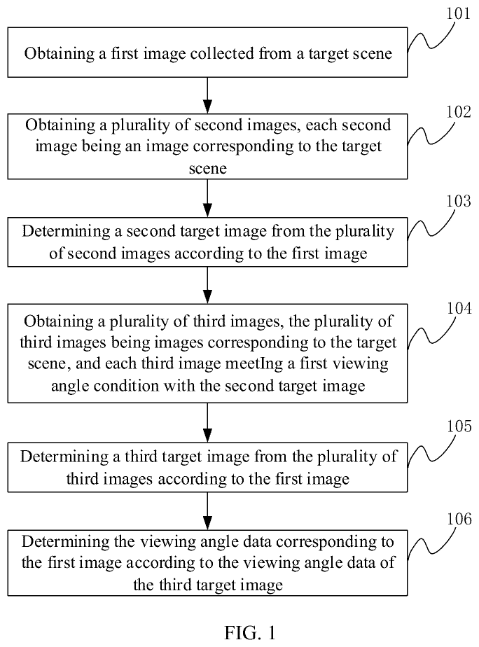

FIG. 1 is a flowchart of a data processing method according to some embodiments of the present disclosure. The method may be applied to an electronic device capable of image processing, such as a smart phone, a computer, or a server. The technical solution in the present disclosure is mainly used to achieve perspective positioning of images and reduce the complexity of the perspective positioning. Alternatively, perspective positioning may also be called viewing angle positioning. As shown in FIG. 1, the method may include the following processes.

At 101: a first image collected from a target scene is obtained.

The target scene may be an indoor scene or an outdoor scene, such as an office, a shopping mall, or a pedestrian street.

Specifically, in some embodiments, the first image may be collected from the target scene by an image acquisition device. In some other embodiments, the first image may be retrieved from images stored in a database, and the database stores at least one image collected from the target scene.

For example, in some embodiments, the first image is collected in a shopping mall by an image acquisition device such as a camera.

At 102: a plurality of second images are obtained, and each second image is an image corresponding to the target scene.

It should be noted that the plurality of second images are images corresponding to the target scene but not obtained by an image acquisition device for the target scene.

In some embodiments, a neural radiance fields (NERF) model is pre-constructed for the target scene, and the plurality of second images may be images obtained based on the NERF model. The NERF model is obtained by collecting and training a sequence of images of the target scene.

In some embodiments, a three-dimensional (3D) model is pre-constructed for the target scene, and the plurality of second images are images obtained based on the 3D model;

In some embodiments, an image library is pre-constructed for the target scene, and the image library stores multiple images corresponding to the target scene, and the plurality of second images are images retrieved from the image library.

At 103, a second target image is determined from the plurality of second images according to the first image.

The second target image is an image in the plurality of second images that meet a target similarity condition with the first image.

In some embodiments, 103 may first determine similarity information between the first image and each second image, and then obtain the second target image according to the similarity information.

In one example, the first image is compared with each second image according to pixel values on the corresponding pixel points for similarity, to obtain the similarity information between the first image and each second image respectively, and then the second image whose similarity information is greater than or equal to a similarity threshold is determined as the second target image.

In another example, image features extracted from the first image are respectively compared with image features extracted from each second image, to obtain the similarity information between the first image and each second image, and then the second image whose similarity information is greater than or equal to the similarity threshold is determined as the second target image.

In another example, the similarity information between the first image and each second image is obtained by a similarity recognition model. The similarity recognition model is trained with two input images as input and a similarity label value as output. The similarity label value is the similarity information between the two input images. The second image whose similarity information is greater than or equal to the similarity threshold is determined as the second target image.

In some embodiments, 103 may first identify object images in the first image and each second image, and then obtain the second target image according to matching situation between the object images in the first image and each second image.

The matching situation represents the similarity information between the object images.

For example, at 103, the object image in the first image and the object image in each second image are respectively identified by an image recognition algorithm. The object image in the first image is matched with the object image in each second image to obtain the matching situation of the first image and each second image on the object image. The matching situation represents the similarity information of the first image and each second image on the object image. Then, the second image whose matching situation meets the target similarity condition, such as the similarity information being greater than or equal to the similarity threshold, is determined as the second target image.

At 104: a plurality of third images are obtained. The plurality of third images are images corresponding to the target scene, and each third image meets a first viewing angle condition with the second target image.

Each third image and the second target image satisfy the first viewing angle condition means that viewing angle data of each third image and viewing angle data of the second target image satisfy a viewing angle similarity condition. The viewing angle similarity condition may be that a difference between the viewing angle data is less than or equal to a corresponding difference threshold, or an area of a viewing angle range where the viewing angle data is located is less than or equal to a corresponding area threshold, etc.

In some embodiments, when obtaining the plurality of third images at 104, a first viewing angle range can be determined according to the viewing angle data of the second target image. Then, multiple first viewing angle data are determined in the first viewing angle range. For example, multiple viewing angle data are randomly selected as the multiple first viewing angle data in the first viewing angle range. The multiple first viewing angle data are uniformly distributed in the first viewing angle range. Then, the plurality of third images are obtained according to the multiple first viewing angle data, and the plurality of third images are mapped one by one with the first viewing angle data, that is, each third image corresponds to one of the first viewing angle data.

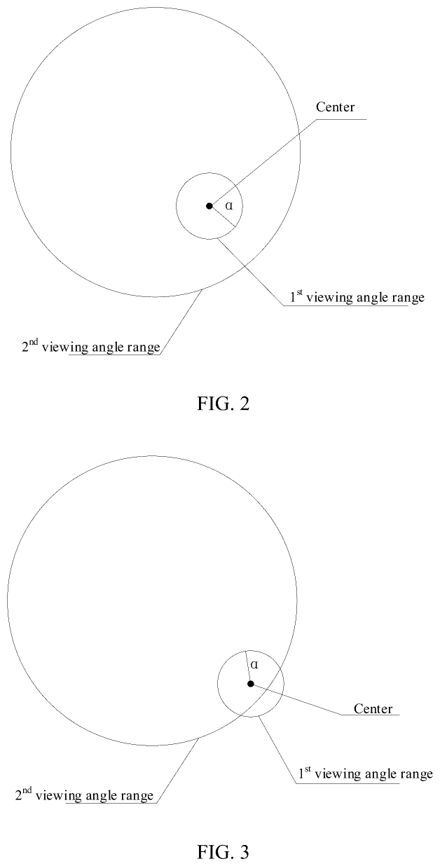

In some embodiments, the plurality of second images at 102 are obtained according to a second viewing angle range. Based on this, when determining the first viewing angle range according to the viewing angle data of the second target image at 104, the first viewing angle range can be determined from the second viewing angle range according to the viewing angle data of the second target image, and the first viewing angle range is included in the second viewing angle range. For example, the first viewing angle range is a viewing angle range with a radius of a centered on the viewing angle data of the second target image within the second viewing angle range, as shown in FIG. 2.

In some embodiments, the plurality of second images at 102 are obtained according to the second viewing angle range. Based on this, when determining the first viewing angle range according to the viewing angle data of the second target image at 104, it can be determined that the viewing angle data of the second target image and the boundary of the second viewing angle range meet a first distance condition. The first distance condition is that a minimum difference between the viewing angle data of the second target image and the viewing angle data on the boundary of the second viewing angle range is less than or equal to a corresponding boundary threshold, that is, the viewing angle range of the second target image is close to the boundary of the second viewing angle range. At this time, the first viewing angle range is determined according to the viewing angle data of the second target image, and the first viewing angle range and the second viewing angle range partially overlap. For example, the first viewing angle range is a viewing angle range with a radius of a centered on the viewing angle data of the second target image and partially overlaps with the second viewing angle range, as shown in FIG. 3.

It should be noted that if the viewing angle data of the second target image and the boundary of the second viewing angle range do not meet the first distance condition, that is, a minimum difference between the viewing angle data of the second target image and the viewing angle data on the boundary of the second viewing angle range is greater than the boundary threshold, that is, the viewing angle range of the second target image is far from the boundary of the second viewing angle range, then the first viewing angle range can be determined from the second viewing angle range according to the viewing angle data of the second target image, and the first viewing angle range is included in the second viewing angle range. For example, the first viewing angle range is a viewing angle range with a radius of a centered on the viewing angle data of the second target image and included in the second viewing angle range, as shown in FIG. 2.

In some embodiments, at 104, when obtaining the plurality of third images, the multiple first viewing angle data may be determined according to the viewing angle data of the second target image, and the first viewing angle data may be obtained as previously described. The multiple first viewing angle data are input into a first model to obtain the plurality of third images. The first model herein is trained to output viewing angle images corresponding to the viewing angle data in the target scene when receiving the viewing angle data in the target scene. For example, the first model may be a 3D model trained for the target scene. After receiving the first viewing angle data, the 3D model may output the viewing angle images corresponding to the first viewing angle data, i.e., the plurality of third images. Alternatively, the first model may be a NERF model constructed for the target scene. After receiving the first viewing angle data, the NERF model may output the viewing angle images corresponding to the first viewing angle data, i.e., the plurality of third images.

In some embodiments, when the viewing angle data of the second target image and the viewing angle data of the first image satisfy a first angle relationship, the viewing angle data of one of the plurality of third images obtained at 104 and the viewing angle data of the second target image satisfy a second angle relationship.

Whether the viewing angle data of the second target image and the viewing angle data of the first image satisfy the first angle relationship can be determined as follows. The second target image and the first image are analyzed for their image contents. When the image content of the second target image and the image content of the first image satisfy a first similarity condition, the viewing angle data of the second target image and the viewing angle data of the first image satisfy the first angle relationship. When the image content of the second target image and the image content of the first image do not satisfy the first similarity condition, the viewing angle data of the second target image and the viewing angle data of the first image do not satisfy the first angle relationship.

The first similarity condition herein may include the following. The similarity of the image contents whose quantity exceeds a first quantity threshold among the multiple image contents identified by the second target image and the multiple image contents identified by the first image is greater than or equal to a content similarity threshold. Attitudes of the image contents in the second target image is the same as that of the image contents in the first image, and an image area of the image contents in the second target image is different from that of the image contents in the first image. That is, the quantity of the same image contents contained in the second target image and the first image exceeds the first quantity threshold, and the same image contents have the same attitudes in the second target image and the first image but are different in size. For example, a building is contained in both the second target image and the first image, and the building has the same attitude (i.e., orientation) in the second target image and the first image but is different in size.

Based on the above description, the second angle relationship matches the first angle relationship. That is, in some embodiments, when obtaining the plurality of third images, the viewing angle data may be kept consistent with the viewing angle data of the second target image. Multiple positions are selected and the corresponding viewing angle images at the multiple positions are used as the plurality of third images. For example, shooting positions corresponding to the plurality of third images under a same viewing angle are different.

In some embodiments, when the viewing angle data of the second target image and the viewing angle data of the first image satisfy a first position relationship, the viewing angle data of each third image and the viewing angle data of the second target image satisfy a second position relationship.

Whether the viewing angle data of the second target image and the viewing angle data of the first image satisfy the first position relationship can be determined in the following manner. The second target image and the first image are analyzed for their image contents. When the image content of the second target image and the image content of the first image satisfy a second similarity condition, the viewing angle data of the second target image and the viewing angle data of the first image satisfy the first position relationship. When the image content of the second target image and the image content of the first image do not satisfy the second similarity condition, the viewing angle data of the second target image and the viewing angle data of the first image do not satisfy the first position relationship.

The second similarity condition herein may include the following. The similarity of the image contents whose quantity exceeds a second quantity threshold among the multiple image contents identified by the second target image and the multiple image contents identified by the first image is greater than or equal to the content similarity threshold. The image areas of the multiple image contents in the second target image are the same as the image areas of the multiple image contents in the first image, and the attitude of the multiple image contents in the second target image is different from that of the multiple image contents in the first image. That is, the quantity of the same image contents contained in the second target image and the first image exceeds the second quantity threshold, and these same image contents are the same in size but different in the attitudes in the second target image and the first image. For example, the second target image and the first image both contain a certain building, and the building has a same size in the second target image and the first image but different attitudes.

Based on the above description, the second position relationship matches the first position relationship. That is, in some embodiments, when obtaining the plurality of third images, a shooting position can be kept consistent with a shooting position corresponding to the second target image. Multiple viewing angle data may be selected and the viewing angle images corresponding to the multiple viewing angle data may be used as the plurality of third images. For example, the shooting angles corresponding to the plurality of third images at the same shooting position are different.

At 105, a third target image is determined from the plurality of third images according to the first image.

The third target image is an image in the plurality of third images that meets the target similarity condition with the first image.

In some embodiments, the similarity information between the first image and each third image may be determined respectively, and then the third target image is obtained according to the similarity information.

In one example, the first image is compared with each third image according to the pixel values on the corresponding pixel points for similarity, to obtain the similarity information between the first image and each third image respectively, and then the third image whose similarity information is greater than or equal to the similarity threshold is determined as the third target image.

In another example, the image features extracted from the first image are respectively compared with the image features extracted from each third image to obtain the similarity information between the first image and each third image, and then the third image whose similarity information is greater than or equal to the similarity threshold is determined as the third target image.

In another example, the similarity information between the first image and each third image is obtained by the similarity recognition model. The third image whose similarity information is greater than or equal to the similarity threshold is determined as the third target image.

In some embodiments, 105 may first identify the object images in the first image and each third image, and then obtain the third target image according to the matching situation between the object images in the first image and each third image.

The matching situation represents the similarity information between the object images.

For example, at 105, the object image in the first image and the object image in each third image are respectively identified by the image recognition algorithm. The object image in the first image is matched with the object image in each third image to obtain the matching situation of the first image and each third image on the object image. The matching situation represents the similarity information of the first image and each third image on the object image. Then, the third image whose matching situation meets the target similarity condition, such as the similarity information being greater than or equal to the similarity threshold, is determined as the third target image.

At 106: the viewing angle data corresponding to the first image is determined according to the viewing angle data of the third target image.

In some embodiments, the viewing angle data of the third target image may be used as the viewing angle of the first image.

In some embodiments, the viewing angle data of the third target image may be adjusted according to the matching situation of the third target image and the first image on the object image, and the adjusted viewing angle data may be used as the viewing angle data corresponding to the first image.

For example, the third target image and the first image both contain a certain building, and the building has a same size in the third target image and the first image, and only has a slight difference in the attitudes. As such, according to the difference in the attitudes, the viewing angle data of the third target image is slightly adjusted, thereby obtaining the viewing angle data of the first image.

From the above technical scheme, it can be seen that in the data processing method provided in the embodiments of the present disclosure, after the first image in the target scene is collected, the plurality of images corresponding to the target scene are obtained. The corresponding target image is screened out from them, and then the images corresponding to the plurality of target scenes are re-obtained based on a first viewing angle relationship, such that the corresponding target image is screened out again, and then the viewing angle data of the screened target image is determined as the viewing angle data of the first image. It can be seen that, different from the method of achieving the perspective positioning by means of satellites and the like in the prior art, the target image is obtained by screening the plurality of images corresponding to the target scene, and then the viewing angle data of the image collected in the target scene is positioned based on the viewing angle data of the target image, thereby reducing positioning complexity.

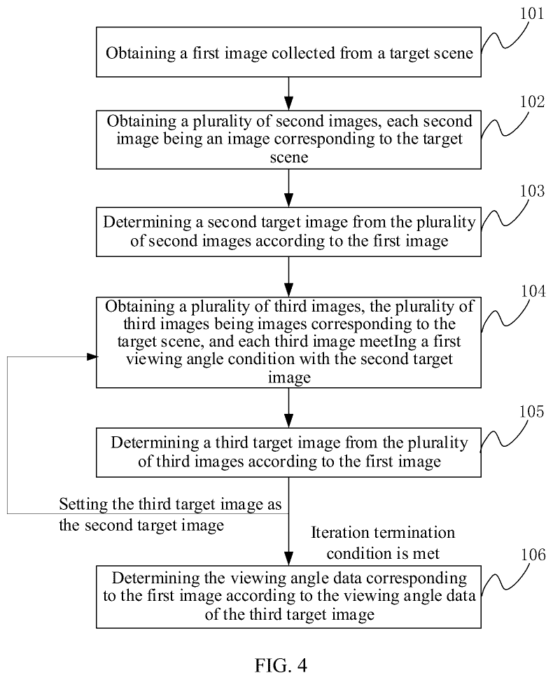

The third target image may be used as the second target image, and 104 is executed until an iteration termination condition is met. For example, the number of iterations exceeds a threshold or the third target image and the first image meet a target condition, as shown in FIG. 4.

The target condition herein may be that the similarity information between the third target image and the first image is greater than or equal to a preset target threshold. For example, the similarity between the third target image and the first image is greater than 99.9%. Thus, multiple screenings are implemented through multiple iterations, such that the viewing angle data obtained at 106 is more accurate.

In some embodiments, when obtaining the plurality of second images, 102 may be implemented in the following manner. A plurality of initial images are obtained. The plurality of initial images are images corresponding to the target scene. The plurality of initial images herein may include at least one of the following: a plurality of randomly determined images or a plurality of images selected by preset information. For example, the plurality of images are randomly determined as initial images in the NERF model. For example, the plurality of images are selected as initial images according to preset viewing angle data in the NERF model.

Then, the plurality of second images are obtained according to the plurality of initial images and the first image.

In some embodiments, the plurality of images that meet an initial condition with the first image may be directly selected from the plurality of initial images as the plurality of second images. The initial condition herein may be: the similarity information is greater than or equal to an initial threshold. That is, the plurality of images whose similarity information with the first image is greater than or equal to the initial threshold are selected from the plurality of initial images as the plurality of second images. Then, the second target image whose similarity information with the first image is greater than or equal to the similarity threshold is selected from the plurality of second images in 103.

In some embodiments, an image that meets the target similarity condition with the first image may be selected from the plurality of initial images as an intermediate image, and then the plurality of images that meet the first viewing angle relationship with the intermediate image are obtained according to the intermediate image, that is, the second image.

For the specific implementation method of obtaining the intermediate image, reference can be made to the method of obtaining the second target image or the third target image in the above description. For the method of obtaining the plurality of images that meet the first viewing angle relationship with the intermediate image according to the intermediate image, reference can be made to the method of obtaining the plurality of third images in the above description.

For example, a NERF model is pre-constructed for the target scene. In some embodiments, a plurality of initial images may be first generated through the NERF model according to randomly selected viewing angle data, and the first image is used to screen out an intermediate image that satisfies the target similarity condition with the first image from the plurality of initial images. Multiple viewing angle data are randomly selected from a viewing angle range with the viewing angle data of the intermediate image as the center and a radius of a, and the corresponding images are generated as the plurality of second images through the NERF model according to the multiple viewing angle data. The second target image that meets the target similarity condition with the first image is screened out from the plurality of second images. The plurality of viewing angle data are randomly selected from another viewing angle range with the viewing angle data of the second target image as the center and a radius of a. The multiple viewing angle data are used to generate corresponding images as the plurality of third images through the NERF model. The third target image that meets the target similarity condition with the first image is screened out from the plurality of third images. The third target image is used as the second target image, and multiple viewing angle data are randomly selected from another viewing angle range with the view angle data of the second target image as the center and the radius a. The multiple viewing angle data are used to generate corresponding images as the plurality of third images through the NERF model. The third target image that meets the target similarity condition with the first image is screened out from the plurality of third images. The above processes iterate until the number of iterations exceeds the threshold or the third target image and the first image meet the target condition. Then, the viewing angle data of the first image may be determined according to the viewing angle data of the third target image.

It should be noted that the plurality of second images and the plurality of third images are obtained in the same way, and the number of the plurality of third images is greater than the number of the plurality of second images. Therefore, after the second target image is screened out through the plurality of second images, more third images can be used to screen images with higher viewing angle accuracy, to obtain the third target image, thereby making the viewing angle data corresponding to the obtained first image more accurate.

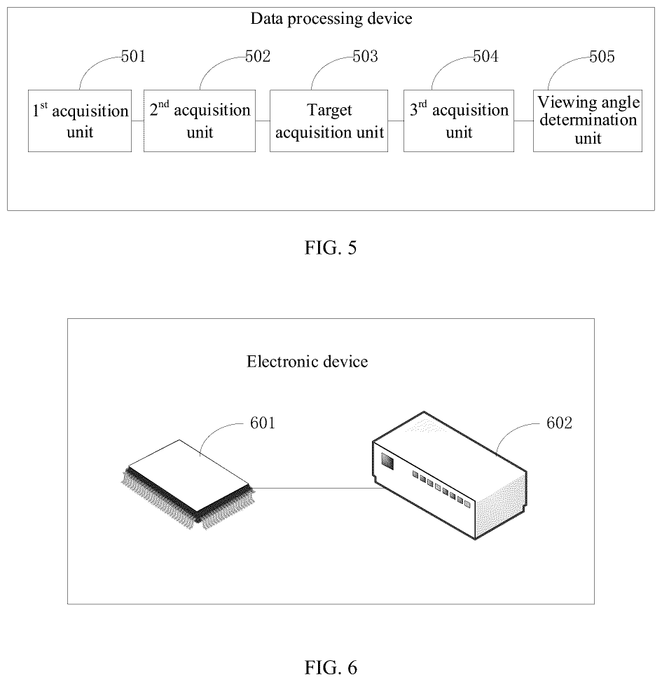

FIG. 5 is a structural diagram of a data processing device according to some embodiments of the present disclosure. The data processing device may be configured in an electronic device capable of image processing, such as a computer or a server. The technical solution in the present disclosure is mainly used to achieve the viewing angle positioning of the image and reduce the complexity of the viewing angle positioning.

Specifically, the data processing device may include: a first acquisition unit 501, a second acquisition unit 502, a target acquisition unit 503, a third acquisition unit 504, and a viewing angle determination unit 505. The first acquisition unit 501 is configured to obtain a first image collected from the target scene. The second acquisition unit 502 is configured to obtain a plurality of second images. The plurality of second images are images corresponding to the target scene. The target acquisition unit 503 is configured to determine a second target image from the plurality of second images according to the first image. The third acquisition unit 504 is configured to obtain a plurality of third images. The plurality of third images are images corresponding to the target scene. Each third image satisfies a first viewing angle relationship with the second target image. The target acquisition unit 503 is further configured to determine a third target image from the plurality of third images according to the first image. The viewing angle determination unit 505 is configured to determine the viewing angle data corresponding to the first image according to the viewing angle data of the third target image.

It can be seen from the above technical solution that in the data processing device provided by the present disclosure, after the first image in the target scene is collected, the plurality of images corresponding to the target scene are obtained. The corresponding target image is screened out from the plurality of images. The images corresponding to the plurality of target scenes are re-obtained based on the first viewing angle relationship, such that the corresponding target image is screened out again. The viewing angle data of the screened target image is used to determine the viewing angle data of the first image. It can be seen that, different from the solution of achieving the view angle positioning by means of satellites and other methods in the prior art, the target image is obtained by screening the plurality of images corresponding to the target scene. The viewing angle data of the images collected in the target scene may be positioned based on the viewing angle data of the target image, thereby reducing the complexity of positioning.

In some embodiments, the second acquisition unit 502 is further configured to: obtain a plurality of initial images. The plurality of initial images are images corresponding to the target scene. The plurality of initial images include at least one of the following: multiple randomly determined images, or multiple images selected by preset information. The plurality of second images are obtained according to the multiple initial images and the first image.

In some embodiments, when determining the second target image from the plurality of second images according to the first image, the target acquisition unit 503 is at least configured to determine the similarity information between the first image and each second image and obtain the second target image according to the similarity information; or identify the object image in the first image and each second images, and obtain the second target image according to the matching situation of the object image in the first image and each second image.

In some embodiments, the third acquisition unit 504 is further configured to: determine the first viewing angle range according to the viewing angle data of the second target image; determine multiple first viewing angle data in the first viewing angle range; and obtain the plurality of third images according to the multiple first viewing angle data. In some embodiments, the plurality of second images are obtained according to the second viewing angle range, and the third acquisition unit 504 is further configured to: determine the first viewing angle range from the second viewing angle range according to the viewing angle data of the second target image. The first viewing angle range is included in the second viewing angle range.

In some embodiments, the plurality of second images are obtained according to the second viewing angle range. When determining the first viewing angle range according to the viewing angle data of the second target image, the third acquisition unit 504 is further configured to: determine that the viewing angle data of the second target image and the boundary of the second viewing angle range meet the first distance condition; and determine the first viewing angle range according to the viewing angle data of the second target image. The first viewing angle range partially overlaps with the second viewing angle range.

In some embodiments, the third acquisition unit 504 is further configured to: determine multiple first viewing angle data according to the viewing angle data of the second target image; input the multiple first viewing angle data into the first model to obtain the plurality of third images. The first model is trained to output the viewing angle image corresponding to the viewing angle data in the target scene when receiving the viewing angle data in the target scene.

In some embodiments, the plurality of second images and the plurality of third images are obtained in the same manner, and the number of the plurality of third images is greater than the number of the plurality of second images.

In some embodiments, when the viewing angle data of the second target image and the viewing angle data of the first image satisfy the first angle relationship, the viewing angle data of the corresponding third image and the viewing angle data of the second target image satisfy the second angle relationship. In some other embodiments, when the viewing angle data of the second target image and the viewing angle data of the first image satisfy the first position relationship, the viewing angle data of the corresponding third image and the viewing angle data of the second target image satisfy the second position relationship.

It should be noted that, for specific implementation of each unit in the present disclosure, reference can be made to the corresponding content in the previous description, which will not be described in detail herein.

FIG. 6 is a structural diagram of an electronic device according to some embodiments of the present disclosure. The electronic device may be a device capable of data processing, such as a computer or a server. The electronic device may include a memory 601 and a processor 602. The memory 601 is configured to store computer programs and data generated by the operation of the computer programs. The processor 602 is configured to execute the computer programs to perform: obtaining a first image collected from a target scene; obtaining a plurality of second images, the plurality of second images being images corresponding to the target scene; determining a second target image from the plurality of second images according to the first image; obtaining a plurality of third images, the plurality of third images being images corresponding to the target scene, and each third image satisfying a first viewing angle relationship with the second target image; determining a third target image from the plurality of third images according to the first image; determining viewing angle data corresponding to the first image according to viewing angle data of the third target image.

It can be seen from the above technical solution that in the electronic device of the present disclosure, after collecting the first image in the target scene, by obtaining a plurality of images corresponding to the target scene, the corresponding target image is screened out, and then a plurality of images corresponding to the target scene are re-obtained based on the first viewing angle relationship, such that the corresponding target image is screened out again, and then the viewing angle data of the screened target image is determined as the viewing angle data of the first image. It can be seen that, different from the solutions in the prior art that use satellites and other means to achieve the viewing angle positioning, the present disclosure obtains the target image by screening the plurality of images corresponding to the target scene, and then locating the viewing angle data of the images captured in the target scene based on the viewing angle data of the target image, thereby reducing the complexity of positioning.

Taking the scene of a pedestrian street as an example, the present disclosure includes: collecting a sequence of images in advance, generating the NERF file of the current scene through NERF training, and generating sparse viewing angle images and attitudes in NERF for positioning.

When viewing angle positioning is required, a current image is compared with each of the images with the sparse viewing angles for similarity. A new sparse map is regenerated through NERF in an adjacent viewing angle range of the most similar sparse map until the iteration is terminated (e.g., the number of iterations reaches the threshold or the screened image is substantially similar to the current image), and the attitude corresponding to the most similar image is output.

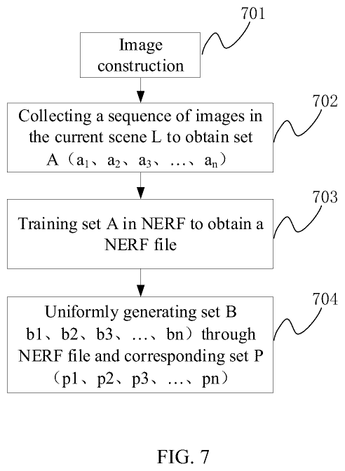

FIG. 7 is a flowchart of NERF mapping according to some embodiments of the present disclosure. As shown in FIG. 7, the NERF mapping includes the following processes.

At 702, a sequence of images are collected in the current scene L to obtain set A (a1, a2, a3, . . . , an).

At 703, set A is trained in NERF to obtain a NERF file (NERF.file).

At 704, a plurality of images are uniformly generated through NERF.file, such as set B (b1, b2, b3, . . . , bn), and each image corresponds to an attitude (i.e., viewing angle or perspective), such as set P (p1, p2, p3, . . . , pn).

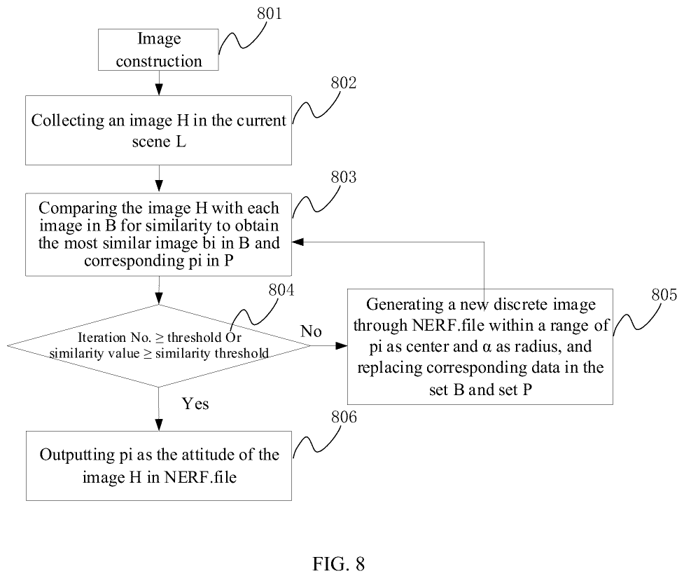

FIG. 8 is a flowchart of viewing angle positioning in a pedestrian street scene L according to some embodiments of the present disclosure. As shown in FIG. 8, the viewing angle positioning includes the following processes.

At 802, an image H is collected in the current scene L.

At 803, the image H is compared with each image in B for similarity to obtain the most similar image bi in B and corresponding pi in P.

At 804, whether the number of iterations has reached the threshold or the similarity value has reached the similarity threshold.

At 805, a new discrete image is generated through NERF.file within a range of pi as the center and a as the radius, corresponding data in the sets B and P are replaced. Subsequently, 803 is performed to obtain the most similar image bi in B and pi in P until the number of iterations reaches the threshold or the similarity value reaches the similarity threshold.

At 806, pi is output as the attitude of the image H in NERF.file.

It can be seen that NERF mapping is adopted in the embodiments of the present disclosure, and positioning is achieved based on the iteration method of image comparison. Therefore, the technical solution of the present disclosure can achieve substantially precise positioning and a wider viewing angle range of positioning.

In this specification, each embodiment is described in a progressive manner, and each embodiment focuses on the differences from other embodiments. The same and similar parts between the embodiments can be referred to each other. For the device disclosed in the embodiments of the present disclosure, because it corresponds to the method disclosed in the embodiments of the present disclosure, the description thereof is relatively simple, and the relevant parts can be referred to the corresponding method description.

Professionals may further realize that the units and algorithm processes of each example described in conjunction with the embodiments disclosed herein can be implemented by electronic hardware, computer software, or a combination thereof. To clearly illustrate the interchangeability of hardware and software, the composition and processes of each example have been generally described in the above description according to functionality. Whether these functions are performed in hardware or software depends on the specific application and design constraints of the technical solution. Professional and technical personnel may use different methods to implement the described functions for each specific application, but such implementation should not be considered to be beyond the scope of the present disclosure.

The processes of the method or algorithm described in conjunction with the embodiments disclosed herein can be directly implemented by hardware, software modules executed by a processor, or a combination thereof. The software module may be placed in a random-access memory (RAM), an internal memory, a read-only memory (ROM), an electrically programmable ROM, an electrically erasable programmable ROM, a register, a hard disk, a removable disk, a CD-ROM, or any other form of storage medium known in the technical field.

The above description of the disclosed embodiments enables professional and technical personnel in this field to implement or use the present disclosure. Various modifications to these embodiments will be apparent to those skilled in the art, and the general principles defined herein may be implemented in other embodiments without departing from the spirit or scope of the present disclosure. Therefore, the present disclosure will not be limited to the embodiments shown herein, but will conform to the broadest scope consistent with the principles and novel features disclosed herein.

What is claimed is:

1. A data processing method, comprising:
obtaining a first image collected from a target scene;
obtaining a plurality of second images, each second image being an image corresponding to the target scene;
determining a second target image from the plurality of second images according to the first image;
obtaining a plurality of third images, the plurality of third images being images corresponding to the target scene, and each third image meeting a first viewing angle condition with the second target image;
determining a third target image from the plurality of third images according to the first image; and
determining viewing angle data corresponding to the first image according to viewing angle data of the third target image.

2. The data processing method according to claim 1, wherein obtaining the plurality of second images comprises:
obtaining a plurality of initial images, the plurality of initial images being images corresponding to the target scene and including at least one of the following: a plurality of randomly determined images or a plurality of images selected by preset information; and
obtaining the plurality of second images according to the plurality of initial images and the first image.

3. The data processing method according to claim 1, wherein determining the second target image from the plurality of second images according to the first image comprises:
determining similarity information between the first image and each second image, and obtaining the second target image according to the similarity information; or
identifying object images in the first image and each second image, and obtaining the second target image according to matching situation between the object images in the first image and each second image.

4. The data processing method according to claim 1, wherein obtaining the plurality of third images comprises:
determining a first viewing angle range according to the viewing angle data of the second target image;
determining multiple first viewing angle data in the first viewing angle range; and
obtaining the plurality of third images according to the multiple first viewing angle data.

5. The data processing method according to claim 4, wherein:
the plurality of second images are obtained according to a second viewing angle range; and
determining the first viewing angle range according to the viewing angle data of the second target image includes: determining the first viewing angle range from the second viewing angle range according to the viewing angle data of the second target image, wherein the first viewing angle range is included in the second viewing angle range.

6. The data processing method according to claim 4, wherein:
the plurality of second images are obtained according to a second viewing angle range; and
determining the first viewing angle range according to the viewing angle data of the second target image includes:
determining that the viewing angle data of the second target image and a boundary of the second viewing angle range meet a first distance condition; and
determining the first viewing angle range according to the viewing angle data of the second target image, wherein the first viewing angle range and the second viewing angle range partially overlap.

7. The data processing method according to claim 1, wherein obtaining the plurality of third images comprises:
determining multiple first viewing angle data according to the viewing angle data of the second target image; and
inputting the multiple first viewing angle data into a first model to obtain the plurality of third images, wherein the first model is trained to output viewing angle images corresponding to the viewing angle data in the target scene when receiving the viewing angle data in the target scene.

8. The data processing method according to claim 1, wherein:
the plurality of second images and the plurality of third images are obtained in a same manner; and
the number of the plurality of third images is greater than the number of the plurality of second images.

9. The data processing method according to claim 1, further comprising at least one of:
when the viewing angle data of the second target image and the viewing angle data of the first image satisfy a first angle relationship, the viewing angle data of the corresponding third image and the viewing angle data of the second target image satisfying a second angle relationship; or
when the viewing angle data of the second target image and the viewing angle data of the first image satisfy a first position relationship, the viewing angle data of the corresponding third image and the viewing angle data of the second target image satisfying a second position relationship.

10. A data processing device, comprising a memory storing computer programs and a processor coupled to the memory and configured to execute the computer programs to:
obtain a first image collected from a target scene;
obtain a plurality of second images, each second image being an image corresponding to the target scene;
determine a second target image from the plurality of second images according to the first image;
obtain a plurality of third images, the plurality of third images being images corresponding to the target scene, and each third image meeting a first viewing angle condition with the second target image;
determine a third target image from the plurality of third images according to the first image; and
determine viewing angle data corresponding to the first image according to viewing angle data of the third target image.

11. The data processing device according to claim 10, wherein when obtaining the plurality of second images, the processor is further configured to:
obtain a plurality of initial images, the plurality of initial images being images corresponding to the target scene and including at least one of the following: a plurality of randomly determined images or a plurality of images selected by preset information; and
obtain the plurality of second images according to the plurality of initial images and the first image.

12. The data processing device according to claim 10, wherein when determining the second target image from the plurality of second images according to the first image, the processor is further configured to:
determine similarity information between the first image and each second image, and obtaining the second target image according to the similarity information; or
identify object images in the first image and each second image, and obtaining the second target image according to matching situation between the object images in the first image and each second image.

13. The data processing device according to claim 10, wherein when obtaining the plurality of third images, the processor is further configured to:
determine a first viewing angle range according to the viewing angle data of the second target image;
determine multiple first viewing angle data in the first viewing angle range; and
obtain the plurality of third images according to the multiple first viewing angle data.

14. The data processing device according to claim 13, wherein:
the plurality of second images are obtained according to a second viewing angle range; and
determining the first viewing angle range according to the viewing angle data of the second target image includes: determining the first viewing angle range from the second viewing angle range according to the viewing angle data of the second target image, wherein the first viewing angle range is included in the second viewing angle range.

15. The data processing device according to claim 13, wherein:
the plurality of second images are obtained according to a second viewing angle range; and
determining the first viewing angle range according to the viewing angle data of the second target image includes:
determining that the viewing angle data of the second target image and a boundary of the second viewing angle range meet a first distance condition; and
determining the first viewing angle range according to the viewing angle data of the second target image, wherein the first viewing angle range and the second viewing angle range partially overlap.

16. The data processing device according to claim 10, wherein when obtaining the plurality of third images, the processor is further configured to:
determine multiple first viewing angle data according to the viewing angle data of the second target image; and
input the multiple first viewing angle data into a first model to obtain the plurality of third images, wherein the first model is trained to output viewing angle images corresponding to the viewing angle data in the target scene when receiving the viewing angle data in the target scene.

17. The data processing device according to claim 10, wherein:
the plurality of second images and the plurality of third images are obtained in a same manner; and
the number of the plurality of third images is greater than the number of the plurality of second images.

18. The data processing device according to claim 10, wherein the processor is further configured to perform at least one of:
when the viewing angle data of the second target image and the viewing angle data of the first image satisfy a first angle relationship, the viewing angle data of the corresponding third image and the viewing angle data of the second target image satisfying a second angle relationship; or
when the viewing angle data of the second target image and the viewing angle data of the first image satisfy a first position relationship, the viewing angle data of the corresponding third image and the viewing angle data of the second target image satisfying a second position relationship.
